(19) United States
(12) Patent Application Publication
(10) Pub. No.: US 2021/0051006 A1
(43) Pub. Date: Feb. 18, 2021

(54) BLIND KEY GENERATOR AND EXCHANGE

(71) Applicant: Cipherloc Corporation, Arlington, VA (US)

(72) Inventor: Albert Henry Carlson, Buda, TX (US)

(21) Appl. No.: 16/937,952

(22) Filed: Jul. 24, 2020

Related U.S. Application Data
(63) Continuation of application No. 15/847,409, filed on Dec. 19, 2017.
Application No. 15/847,409 is a continuation of application No. 62/524,048, filed on Jun. 23, 2017.

(51) Int. Cl. H04L 9/08; H04L 9/32

(52) U.S. Cl. CPC H04L 9/0869; G06F 7/588; H04L 2209/08; H04L 9/3278

(57) ABSTRACT

Operationally, the invention transmits a number to a verifiable recipient which indicates to the receiver what the key will be, without sending the key, or some related key. It is an INPUT into a function that takes the inputs to arrive at a completely different key. The idea is that the partial key does not have any resemblance to the final key and does not give the attacker a clue as to what the final key will be, thus, making it far more difficult to find what appears to be a completely unrelated password/key than one that is not obscured. This is also known as using a partial key to transmit a blind key to a verifiable recipient.

### BACKGROUND OF THE INVENTION

Protecting a facility and its electronic based assets is a time consuming and never ending effort. New attacks are developed regularly and the attacker generally has the edge. In computer and network security situations the security professionals attempt to protect all portions of the network from attack, especially the area of cryptography. One of the more difficult problems in cryptography is the sharing of keys.

Methods of safe sharing of keys have been explored and suggested for hundreds of years. The earliest method was developed prior to the widespread use of electronic and wireless equipment—physical delivery of a key to a participant in the conversation. Each party to the conversation was given, or told, the key and kept the key secret. This delivery mechanism suffered from several major problems:
1. It was expensive if the distance between parties was significant
2. It was slow. The longer the distance between participants the longer it took to get the keys to the right person
3. It depended on the courier knowing the identity of parties. The person delivering the keys had to ensure that the recipient was the correct person to get the key or there was a high probability that the key would be compromised
4. The key had to be changed regularly. Without regular and frequent key changes the key could be discovered by cryptanalysis and communications would be compromised. As the skill of cryptanalysts increased the time between updating/changing keys required much more frequent key changes. This, in turn, vastly increased key delivery costs
5. Couriers are targets for attack. Anyone delivering this data can be identified and subjected to theft, injury, coercion, and torture to recover the keys they deliver. This makes in person delivery hazardous and inconsistent
6. The use of larger keys complicates delivery. With the advent of increasingly long keys couriers can no longer memorize keys effectively. Some kind of media is often required. Copying to media also introduces the chance of errors being introduced in the copy process

Other methods were developed with the advent of electrical and electronic communications. Sending a key via telegraph, phone, radio, network, or wireless was faster, cheaper, and easier. Unfortunately, security suffers using these techniques. Problems include:
1. Eavesdroppers. Parties can listen in to the transmission process, recording the keys and allowing attackers to decrypt messages that are intercepted without the knowledge of the parties to the communications
2. It becomes much easier to disrupt the delivery of keys. If the media is disrupted or blocked, such as with a denial of service (DOS/DDOS) attack the delivery can be prevented. If the keys are not delivered then effective communications cease
3. Not being sure of the sender/recipient. It is almost impossible to be able to verify the identity of a sender or recipient. This has proven to be a major problem

Attempts to solve this problem of key distribution have spawned a number of possible solutions. Most involve some sort of encryption, trusted third parties (TTPs), two keys, or splitting up a key into parts. Each of these solution approaches have significant problems. Encryption of the key means pushing the problem of keys one level deeper. TTPs often use certificate authorities (CAs), which add extra cost and complexity. Using several different keys, such as in public key exchanges/public key infrastructures suffers from a CA plus publishing one of the keys, leaving only a single key to be broken. Splitting up the key just means putting together the parts of the key from different sources. While this does increase the difficulty, requiring intercepting the key from multiple sources and reassembling the key, this proves to be vulnerable.

Probably the best approach is to never send the key. This is a difficult problem and limits the number of possible keys. Take the Diffie-Hellman handshake [Schneier 1996] as an example. This is an algorithm for sharing a secret number. In this algorithm two numbers are sent between users. Neither number is the final, secret number. Therefore, the final number is not sent and cannot be intercepted and used. It is possible to brute force the number, but the time it takes to arrive at the right shared number is long enough to prevent real time use of the data. If the key were a secret number this methodology might be sufficient. However, the algorithm cannot send very large numbers and may be limited in the sample space of the numbers sent. Thus, Diffie-Hellman cannot be easily used to send a secret key effectively. The approach is good, never send the data directly and calculate it when received.

A second problem arises when data is stored on a mass media in the encrypted form. This data, known as “data at rest,” or DAR, suffers from a related problem. That problem is safe key storage. Many users now wish to store their data on the media in an encrypted form. However, if the data is encrypted the user must know the key for decryption. While some media use the same key for ALL data on the media, other schemes use various keys for different files on the media. It is probably most secure if EVERY file has its own key. However, if this is the case, then the user must either remember all of the keys and enter them when the file needs to be accessed or the keys must be stored and managed somewhere. This means having a place that, if successfully hacked, would open up the entire media for reading. Often, this area on the media is targeted as the most coveted area on the media. Certainly, these passwords/keys are not listed in plain text. Normally the passwords/keys are encrypted using a hash. While this does provide a certain measure of protection, hashes can be broken. An easy way to attack the hash is to use Rainbow Tables and brute force attacks. The attacks are successful, but if the passwords/keys are changed frequently, but irregularly, the attack only creates a limited time vulnerability. Unfortunately, most people do not change passwords/keys often enough to approximate regularity. Therefore, DAR passwords/keys are a large problem.

Because of this problem a major design goal in security is to create a key at the users machine without sending the key or using standard handshake algorithms. The reasons for this goal can be summarized as:
1. Any key that is stored in a printed or electronic form can be recovered. If a secret should not be revealed, it should not be written down or stored in electronic form. Even encrypted forms of the password/key are vulnerable
2. Standard handshakes can be broken. It may take time to recover the information passed. For example, Diffie-Hellman (the RSA algorithm) passes a shared secret number and only sends OTHER numbers. Recovering the shared number is possible, so this number should not be used as the password/key. Some other number should be used as the password/key
3. It is far more difficult to find what appears to be a completely unrelated password/key than one that is not obscured

### SUMMARY OF THE INVENTION

This invention addresses the problem of sending an encrypted message using some key that is NOT sent, but rather agreed upon without sending the key so that an attacker can listen to the transmission but cannot determine the key.

Operationally, the invention transmits a number to a verifiable recipient which indicates to the receiver what the key will be, without sending the key, or some related key. It is an INPUT into a function that takes the inputs to arrive at a completely different key. The idea is that the partial key does not have any resemblance to the final key and does not give the attacker a clue as to what the final key will be, thus, making it far more difficult to find what appears to be a completely unrelated password/key than one that is not obscured. This is also known as using a partial key to transmit a blind key to a verifiable recipient.

### Terms

The definitions of the following terms shall be used throughout the remainder of this application.

Internet of Things—the inter-networking of physical devices, vehicles (also referred to as “connected devices” and “smart devices”), buildings, and other items embedded with electronics, software, sensors, actuators, and network connectivity which enable these objects to collect and exchange data. It relies upon the Open Systems Interconnect model for device addressability across both Local Area Networks and Wide Area Networks or the External Network.

Network or Computer Network—refers to a group of computing hardware devices, such as laptop computers, desktop computers and servers, that are linked together through physical wiring, special purpose electronic devices and connections that offer electronic communication channels to facilitate communications between the computing hardware and to share resources among a wide range of users. Networks are commonly categorized based on their characteristics.

Local Area Network—refers to a computer telecommunications network that interconnects computers within a limited area such as a residence, school, laboratory, university campus or office building and has its network equipment and interconnects locally managed. It is commonly referred to as a LAN.

Wide Area Network—refers to a computer telecommunications network that interconnects computers and/or LANs over potentially unlimited distances and are often connected through public networks, such as the telephone network, but, can also be connected through leased lines or satellites. It is commonly referred to as a WAN.

External Network—refers to a dynamic network that includes all network addresses not explicitly included in any other network. The network definition changes dynamically when other networks are defined and modified. It cannot be directly modified or deleted. The External network generally represents the Internet.

Open Systems Interconnection Model—(OSI Model) characterizes and standardizes the communication functions of a telecommunication or computing system without regard to their underlying internal structure and technology to achieve interoperability of diverse communication systems with standard protocols. The model partitions a communication system into abstraction layers:

OSI Model

| | Layer | Protocol data unit (PDU) | Function |
|---|---|---|---|
| Host layers | 7. Application | Data | High-level APIs, including resource |
| | | | sharing, remote file access |
| | 6. Presentation | | Translation of data between a |
| | | | networking service and an application; |
| | | | including character encoding, data |
| | | | compression and encryption/decryption |
| | 5. Session | | Managing communication sessions, |
| | | | i.e., continuous exchange of |
| | | | information in the form of multiple |
| | | | back-and-forth transmissions between |
| | | | two nodes |
| | 4. Transport | Segment (TCP) / | Reliable transmission of data segments |
| | | Datagram (UDP) | between points on a network; including |
| | | | segmentation, acknowledgement and |
| | | | multiplexing |
| Media layers | 3. Network | Packet | Structuring and managing a multi-node |
| | | | network; including addressing, routing |
| | | | and traffic control |
| | 2. Data link | Frame | Reliable transmission of data frames |
| | | | between two nodes connected by a |
| | | | physical layer |
| | 1. Physical | Bit | Transmission and reception of raw bit |
| | | | streams over a physical medium |

At each level N, two entities at the communicating devices (layer N peers) exchange protocol data units (PDUs) by means of a layer N protocol. Each PDU contains a payload, called the service data unit (SDU), along with protocol-related headers and/or footers.

Data processing by two communicating OSI-compatible devices is done as such:
1. The data to be transmitted is composed at the topmost layer of the transmitting device (layer N) into a protocol data unit (PDU).
2. The PDU is passed to layer N−1, where it is known as the service data unit (SDU).
3. At layer N−1 the SDU is concatenated with a header, a footer, or both, producing a layer N−1 PDU. It is then passed to layer N−2.
4. The process continues until reaching the lowermost level, from which the data is transmitted to the receiving device.
5. At the receiving device the data is passed from the lowest to the highest layer as a series of SDUs while being successively stripped from each layer's header and/or footer, until reaching the topmost layer, where the last of the data is consumed.

Some orthogonal aspects, such as management and security, involve all of the layers. These services are aimed at improving confidentiality, integrity, and availability of the transmitted data. In practice, the availability of a communication service is determined by the interaction between network design and network management protocols.

Telecommunications Protocol—a set of rules that allow two or more entities of a communications system to transmit information via any kind of variation of a physical quantity. These are the rules or standard(s) that define the syntax, semantics and synchronization of communication and possible error recovery methods. Protocols may be implemented by hardware, software, or a combination of both.

Communications Port (Port) Assignment—functional assignment of 2¹⁶ (65,536) available communications ports used in data communications such that each port on the sending device must mate with the same port on the receiving device such that it has the same function, thus, avoiding contacts of disparate functions (which could cause communications failure).

Network Communications—includes all the communications broadcast and received at each end of a communication path.

Data Stream—refers to all electronic communication between a network of two or more devices.

Universal Serial Bus (USB)—is an industry standard developed in the mid-1990s that defines the cables, connectors and communications protocols used in a bus for connection, communication, and power supply between computers and electronic devices. It is currently developed by the USB Implementers Forum.

Diffie-Hellmann Exchange—allows two parties that have no prior knowledge of each other to jointly establish a shared secret (key) over an insecure channel. This key can then be used to encrypt subsequent communications using a symmetric key cipher.

Physically Unclonable Function—a physical entity that is embodied in a physical structure and is easy to evaluate but hard to predict. The device must be easy to make but practically impossible to duplicate, even given the exact manufacturing process that produced it. In this respect it is the hardware analog of a one-way function.

Public Key Infrastructure—a set of roles, policies, and procedures needed to create, manage, distribute, use, store, and revoke digital certificates and manage public-key encryption to facilitate the secure electronic transfer of information for a range of network activities such as e-commerce, internet banking and confidential email. It is required for activities where simple passwords are an inadequate authentication method and more rigorous proof is required to confirm the identity of the parties involved in the communication and to validate the information being transferred. In cryptography, it is an arrangement that binds public keys with respective identities of entities (like people and organizations). The binding is established through a process of registration and issuance of certificates at and by a certificate authority (CA). Depending on the assurance level of the binding, this may be carried out by an automated process or under human supervision. The PKI role that assures valid and correct registration is called a registration authority and it is responsible for accepting requests for digital certificates and authenticating the entity making the request.

Digital Certificates—also known as a “public key certificate”, is an electronic document used to prove the ownership of a public key. The certificate includes information about the key, information about the identity of its owner (called the subject), and the digital signature of an entity that has verified the certificate's contents (called the issuer). If the signature is valid, and the software examining the certificate trusts the issuer, then it can use that key to communicate securely with the certificate's subject.

Certificate Authority—issues digital certificates that certify the ownership of a public key by the named subject of the certificate. This allows others (relying parties) to rely upon signatures or on assertions made about the private key that corresponds to the certified public key. It is a trusted third party which is trusted both by the subject (owner) of the certificate and by the party relying upon the certificate. The format of these certificates is specified by the X.509 standard.

Registration Authority—an authority in a network that verifies user requests for a digital certificate and tells the certificate authority (CA) to issue it.

True Random Number Generator—a device that generates random numbers from a physical process, rather than a computer program and are often based on microscopic phenomena that generate low-level, statistically random “noise” signals, such as thermal noise, the photoelectric effect, involving a beam splitter, and other stochastic quantum phenomena, which are, in theory, completely unpredictable, and the theory's assertions of unpredictability are subject to experimental test.

Cryptographic Pseudo-Random Number Generator—an algorithm for generating a sequence of numbers whose properties are not truly random, because it is completely determined by an initial value, called the PRNG's seed (which may include truly random values) that approximates the properties of sequences of random numbers and because of its' speed is useful for real-time applications such as cryptography.

Ternary State—in digital electronics, refers to three possible values, −1, 0 and +1 (instead of the more common binary logic of two possible values 0 and 1) wherein the negative value of any balanced ternary digit can be obtained by replacing every + with a − and vice versa, thus, making it easy to subtract a number by inverting the + and − digits and then using normal addition thereby making it easy to express negative values as easily as positive ones, without the need for a leading negative sign, as with decimal numbers, giving the advantage of making some calculations more efficient in ternary than binary.

Static Ramdom Access Memory—a type of semiconductor memory that uses bistable latching circuitry (flip-flop) to store each bit and exhibits data remanence, but it is still volatile in the conventional sense that data is eventually lost when the memory is not powered.

Dynamic Random Access Memory—a type of random-access memory that stores each bit of data in a separate capacitor within an integrated circuit where the capacitor can be either charged or discharged (these two states are taken to represent the two values of a bit, conventionally called 0 and 1) and since even “nonconducting” transistors always leak a small amount, the capacitors will slowly discharge, and the information eventually fades unless the capacitor charge is refreshed periodically.

Flash Memory—an electronic (solid-state) non-volatile computer storage medium that can be electrically erased and reprogrammed.

Resistive Random-Access Memory—a type of non-volatile random-access computer memory that works by changing the resistance across a dielectric solid-state material often referred to as a memristor.

Magnetoresistive Random-Access Memory—data stored as magnetic storage elements with the elements formed from two ferromagnetic plates, each of which can hold a magnetization, separated by a thin insulating layer and one of the two plates is a permanent magnet set to a particular polarity while the other plate's magnetization can be changed to match that of an external field to store memory in order to form what is known as a Magnetic tunnel junction used to build a memory device from a grid of such “cells”.

Memory Arrays—an evolving solid-state storage technology similar to flash memory but with potentially greater storage capacity resulting from the fact that array-based memory is three-dimensional (3D) while most traditional memory and storage media are two-dimensional (2D).

Hash—A hash function is any mathematical function that can be used to map data of arbitrary size to data of fixed size and the values returned by a hash function are called hash values, hash codes, digests, or simply hashes and they are often used in a data structure called a hash table which is widely used in computer software for rapid data lookup by detecting duplicated records in a large file.

Trusted Third Party—in cryptography, a trusted third party (TTP) is an entity which facilitates interactions between two parties who both trust the third party; the Third Party reviews all critical transaction communications between the parties, based on the ease of creating fraudulent digital content.

RSA—developed by Ron Rivest, Adi Shamir, and Leonard Adleman, it is one of the first practical public-key cryptosystems and is widely used for secure data transmission such that the encryption key is public and differs from the decryption key which is kept secret based on the practical difficulty of factoring the product of two large prime numbers, the factoring problem.

Challenge Response Pairs—in computer security, challenge-response authentication is a family of protocols in which one party presents a question (“challenge”) and another party must provide a valid answer (“response”) to be authenticated.

Initialization Vector—a fixed-size input to a cryptographic primitive that is typically required to be random or pseudorandom to achieve semantic security, a property whereby repeated usage of the scheme under the same key does not allow an attacker to infer relationships between segments of the encrypted message.

### BRIEF DESCRIPTION OF THE DRAWINGS

FIG. 1 is a block diagram describing a Public Key Infrastructure for network security.

FIG. 2 is a block diagram of a Public Key Infrastructure protocol protected by distributed Physical Uncloneable Functions.

FIG. 3 is a diagram of the BKE circuit board.

FIG. 4 is a diagram of the BKE connected to a personal computer and a network.

FIG. 5 is a diagram of a personal computer circuit board with the BKE integrated as a Very High Speed Integrated Circuit hardware component.

FIG. 6 is a diagram of a network of IoTs.

FIG. 7 is a diagram of a network with IoTs protected by the BKE.

FIG. 8 is a table showing the parameter for PUF generation

FIG. 9 is a figure showing an RNG Block Structure production.

FIG. 10 is a figure showing the use of the RNG block Structures∧.

### DETAILED DESCRIPTION OF THE INVENTION

The proliferation of connected machines, consumer products, automobiles, drones, and smart grids under the broad concept of Internet of Things (IoT) has created new opportunities for criminals, terrorists, and hackers which has necessitated effective cyber security solutions for commerce and national security.

There are billions of heterogeneous devices on the Internet. Securing those billions of devices is a complex and never ending task. Security is often an afterthought and is usually based on microcontroller architectures that are not necessarily flexible enough to perform and meet the diverse needs of those billions of devices.

Protecting a network interacting with IoTs does not come without its' difficulties, including:
1. Key distribution among network nodes.
2. Protection of the key within the IoTs to avoid side channel attacks.
3. Access to enough computational resources because low cost IoTs may not have the capability to process functions such as exponential modulo that are needed for the protocols.

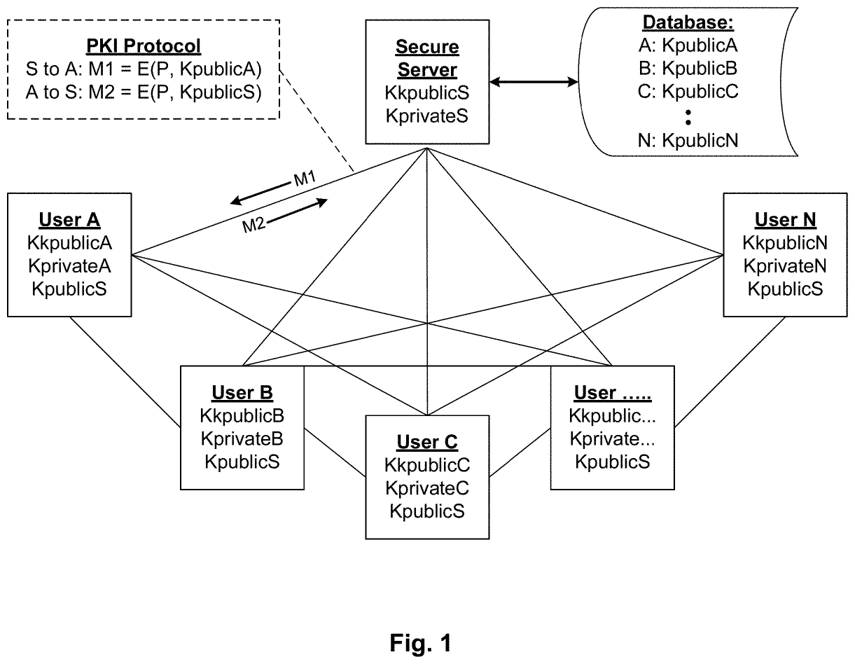

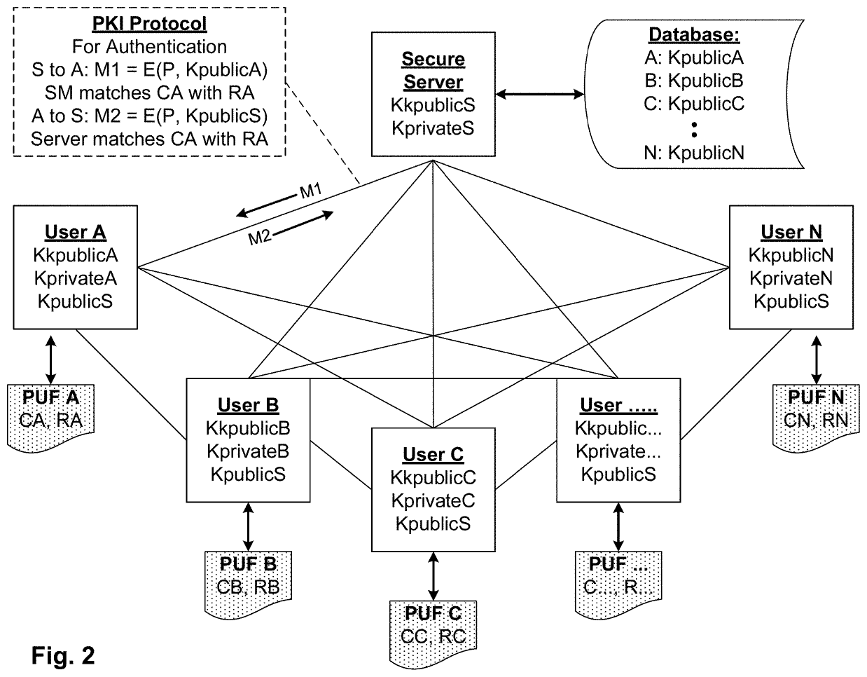

Various methods to overcome these problems have been tried with the most viable being a type of Public Key Infrastructure (PKI), FIG. 1, protocol protected by a distributed Physically Unclonable Function, FIG. 2.

In this invention, the Blind Key Exchange (BKE), we combine a database-free host architecture with a modular microcontroller at the client level with security built in, linked by a secure authentication protocol that uses replaceable security modules to authenticate users and data transmissions.

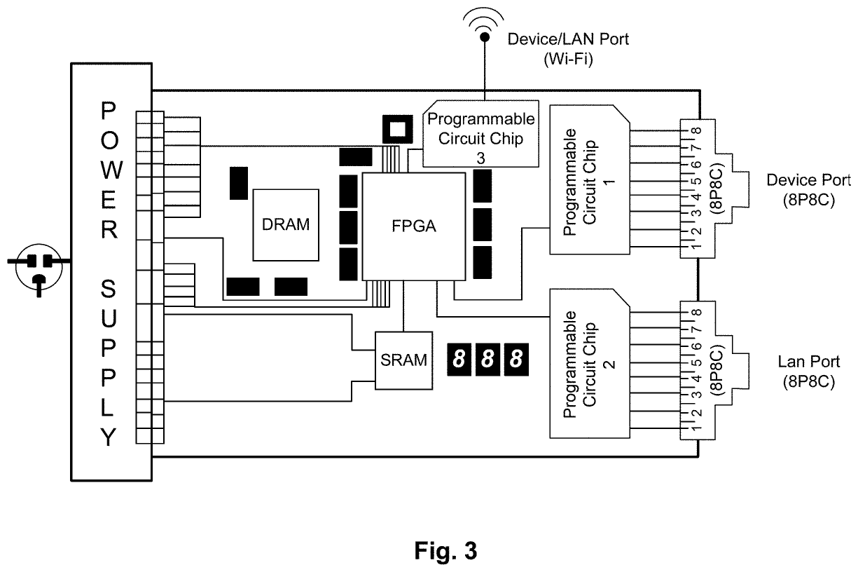

The BKE is implemented as a hardware function as shown in FIG. 3. It consists, primarily, of a Field Programmable Gate Array (FPGA) processor and at least 2 GB of memory dedicated to the tasks identified in this description of operation. The invention can be permanently mounted inside of a computing device, inside of a communications device (e.g. a telephone or FAX), or as an external, USB connected device, such as a standard USB thumb drive.

The BKE publicly sends an encrypted message using a key that is NOT sent, but rather agreed upon without sending the key, thus, negating any efforts by an attacker to listen to the transmission and determine the key. This is accomplished by using a partial key, a number sent to indicate to the receiver what the key will be without sending the key or some related key, as INPUT into a function that takes the inputs to arrive at a completely different key. The partial key does not have any resemblance to the final key and, therefore, does not give the attacker a clue as to what the final key will be.

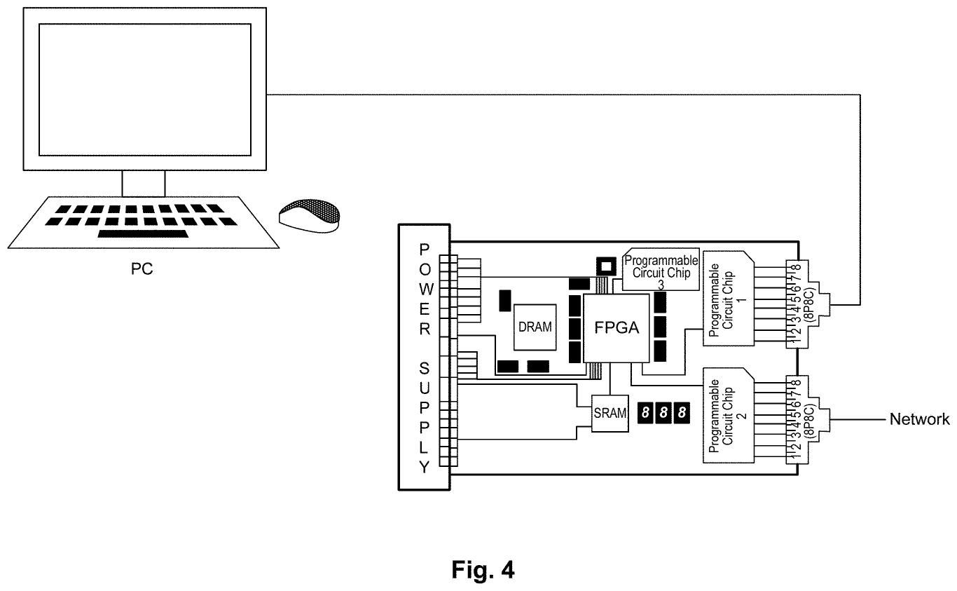

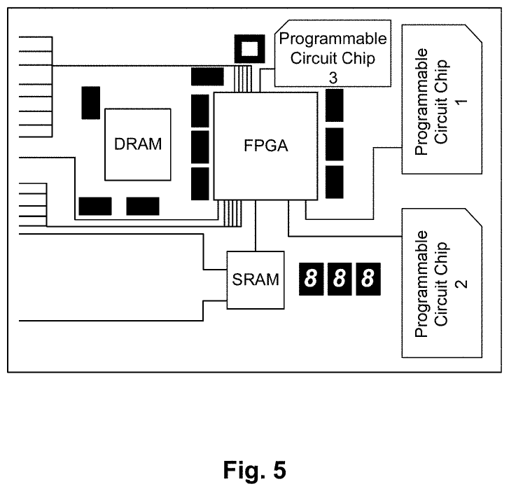

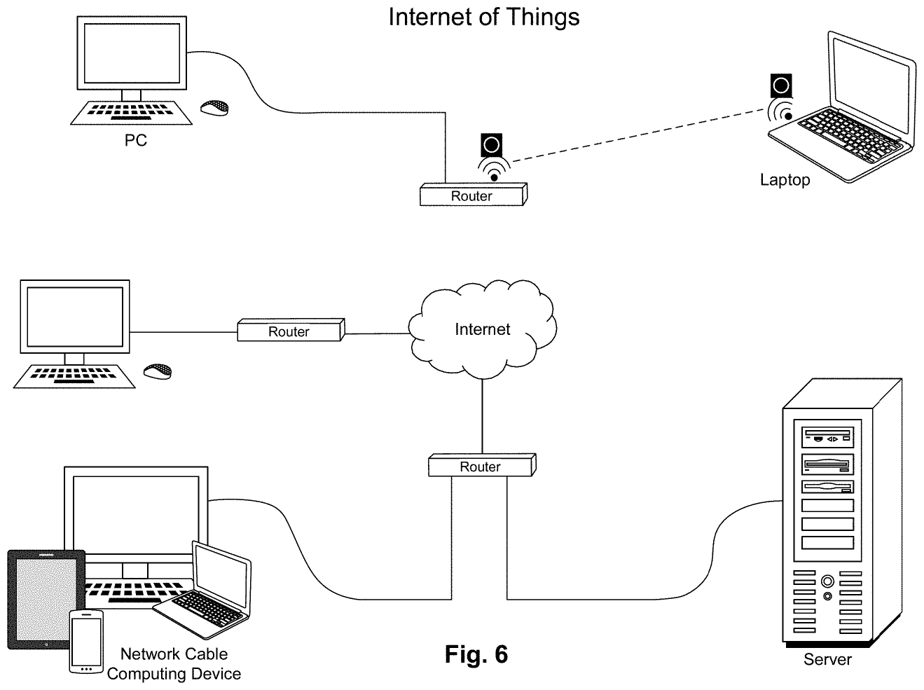

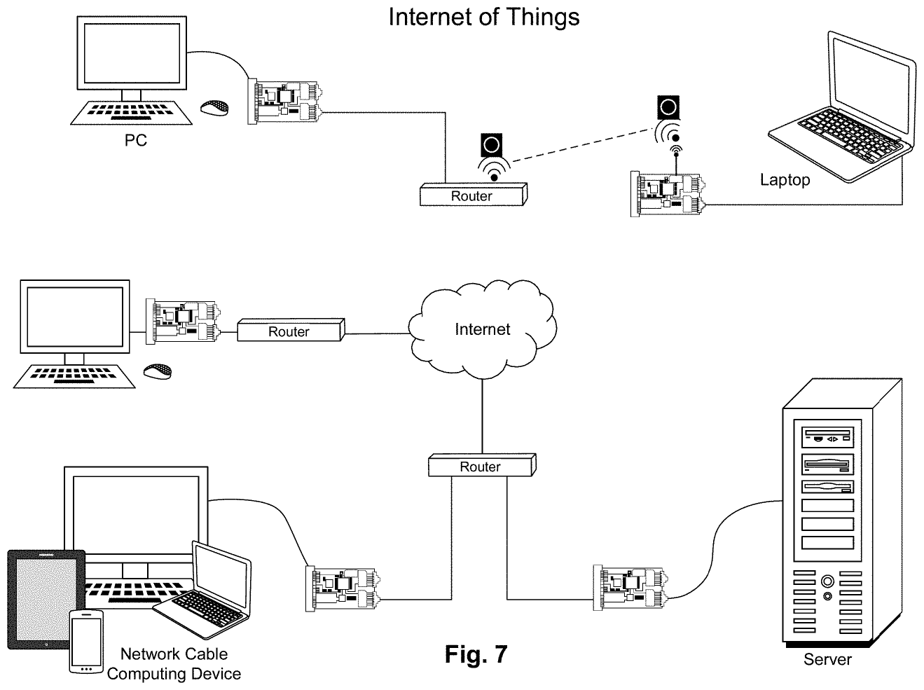

The BKE is either attached to a computing device, FIG. 4 or included in the circuitry of an originating computing or telecommunications device, as shown in FIG. 5. The originating device sends a message over the Internet of Things, FIG. 6, to an intended recipient. But, the BKE, as configured in FIG. 7, intercepts the message in order to secure it with its own process.

When preparing to send an encrypted message, the BKE must, first, develop a partial key (PK) that will be used to develop the final key (FK) used in the actual encryption process prior to transmitting the encrypted message and partial key to the recipient.

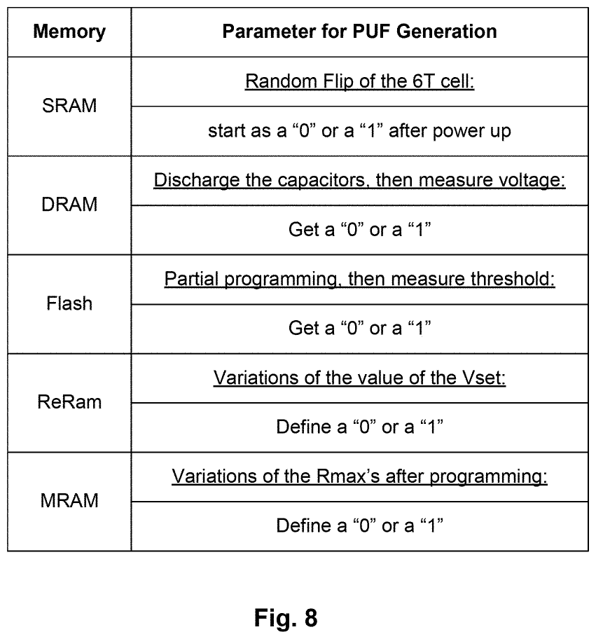

The partial key is derived from Physically Unclonable Functions (PUF) which consist of physical quantities that arise from variations of manufacturing computer memory and various electronic components which are part of the “signature” directly associated with the hardware of a computer and remains with the unit until it is either retired or the parts burn out. Memory based PUFs are utilized and are derived from Static Random Access Memory (SRAM), Dynamic Random Access Memory (DRAM), Flash Memory (FLASH), Resistive Random-Access Memory (ReRAM) and Magnetoresistive Random-Access Memory (MRAM) memory structures, as shown in FIG. 8:

PUFs need 128 to 256 bits to ensure an acceptable level of security and the secure memory arrays (SM) integrated within secure micro-controllers have memory densities in the mega-byte range. Challenge Response Pairs (CRPs) are generated by characterizing a particular parameter PP of the cells with the built-in-self-test (BIST) module. The values of the parameter PP vary from cell to cell and follow a distribution with a median value T. In order to generate challenge and response pairs all cells with PP quantified as “0”, and all others as “1”. Assuming that these measurements are reproducible, the resulting streams of data generated by the method can be used as cryptographic primitives to authenticate the memory array.

Each of these PUFs can be characterized after manufacture and the results stored for later reporting and use. Thus, PUFs can be recorded either at the time they are produced, later when they are used, or even much later when they are put into operation. That data can be used in a database or registered with a particular user or Trusted Third Party (TTP).

Once the partial key is fully developed, the BKE can utilize several different class functions to develop the final key from the partial key:
1. The identity function—The final key is just the bits read from the PUF in the order specified during the process of data handshake/exchange between the users.
2. The XOR function—The final key is derived by doing an XOR with the Initialization Vector and the data from the PUF in the specified order.
3. Functions consisting of combinations of binary primitive functions—The final key is derived by applying the agreed upon function consisting of binary primitive operators with the data from the PUF in the specified order. Binary primitives include the AND, OR, and NOT (inversion) binary functions and can be combined in any order as agreed upon prior to application to derive the key.
4. Trigonometric functions—Any trigonometric function, such as sin, cos, tan, sec, cot, and cosec, as well as their hyper-trigonometric counterparts.
5. Locations of portions of an irrational number sequence—Indexing into an irrational number, such as and choosing from some starting point in the sequence to take the next ≡K| bits as the key. Numerous irrational numbers exist and do not repeat values, any one of which (or selection from among a pool of those numbers) may be selected for use.
6. Other related functions that result in non-repeating values of at least the size of the key—Any equation or number that is known not to repeat for |K| characters is suitable, even though not specified in the preceding descriptions, may also be used to derive the final key.

Any of these functions can be selected, when agreed upon during the initialization sequence seeded by the Initialization Vector and order numbers sent by secret key between users.

The full key is derived from an initial value, an initialization vector (IV) and some subset of a signature (S) as K=ƒ((IV,S).

The signature is some value, or set of values that uniquely identifies a hardware node associated with a particular user. In order to be a valid signature, the signature must be:
1. Unique—that is each node should have its own value that is different from other nodes. The chance of having a duplicated signature should be as close to random as is possible.
2. All components of the signature must be readable by the unit in which they exist, but not readily available to someone outside the system.
3. Records of the signature should exist ONLY in trusted, protected environments (such as a Trusted Third Party, trusted associated, or Certificate Authority), and ONLY where absolutely necessary.
4. The signature must be composed of values that are difficult, if not impossible, to change for a user. Such a value can be placed in permanently attached hardware or can be the serial number placed in the chips. All processors and communications chips have these numbers burned into them so that they can be tracked and cannot be altered. Further, the hardware and memory configuration can also be added into the full signature.
5. The size of the signature should be as large as is possible. The more bits in the total signature the harder it is to know which portions of the signature are used in any final key.
6. The signature should include as many possible byte values as possible.

Signatures are a concatenation of the various PUFs, serial numbers, and other identifying values that look like:

| | | | | | |
|---|---|---|---|---|---|
| S₀ | S₁ | S₂ | S₃ | . . . | Sₙ |

where each Sᵢ is one of the individual signature components making up the entire signature for the unit. For example S₀ could be the processor serial number, S₁ could be the memory configuration, and so on. But, the signature can have many forms. Specifically, the signature can be concatenated in a number of ways. Without having to permute each of the bits, it is easy to permute each of the components of the total signature. This gives a total of n! combinations of the constituent values. The value of n! rises very rapidly—if there are only five components of the total signature there are 125 possible combinations and with ten, there are 3,628,800 possible combinations. Once this order is created, then any number of combinations of the bits in the signature can be selected. This may be done as a set of bytes or a set of bits. The number of possible combinations of the bits/bytes of the signature is

If the choice is bytes, then n is the number of bytes or bits, as appropriate, in the composite signature and is the size of the partial key input in bytes or bits, as appropriate. Then, the combination of those bits can be chosen in any order, resulting in

$$\begin{matrix}( n ) ! \\ {K}_{p}\end{matrix}$$

choices. This gives a large number of inputs into the function that develops the final key.

Now assume that there are m functions that can be used in developing the final key. These functions are placed in a pool and are randomly chosen, but that choice is agreed upon by the users. Choice of the function can be made in the same way that the signature component order, subset of the signature, and order of the bits/bytes are selected: handshake for each exchange, frequent and irregular seeding, interleaved randomized seeding data in the message, or using a key progression value entered at the time of installation. In any case the best situation is to use a CPRNG that approximates a uniformly distributed IRV. Then we can assume that the probability of selecting any function (ƒ₁) in the pool is

$${P}_{r} ( {f}_{i} ) = \frac{1}{\vert p \vert}$$

And the key space for a particular set of messages is the product of the probability off, n!, and |B|!, resulting in a key space of |K|=n!|B|!|P|.

However, so long as the eventually there will be a repeat of the use of keys in the key space. Assuming that the choice is random, the maximum average amount of keys selected by the users before a repeat (or “collision”) is governed by the Birthday paradox [McKinney 1966]. Having a larger key space will reduce the time between collisions.

Using this approach the idea is to try and achieve as uniform a selection of keys, so that the chance of picking a particular key is given by

$$p r ( K = {K}_{node} ) = \frac{1}{\vert S \vert}$$

and the probability of a collision in a particular run of key selections is

$$p r ( n ) = 1 - {( \frac{\vert K \vert - 1}{\vert K \vert} )}^{\frac{( n ( n - 1 ) )}{2}}$$

Where n is the number of items in the run (such as a run of 23) and |K| is the size of key space. Increasing n only helps to decrease the average time between collisions. Again, the number of possible keys is controlled via the functions and signature space used.

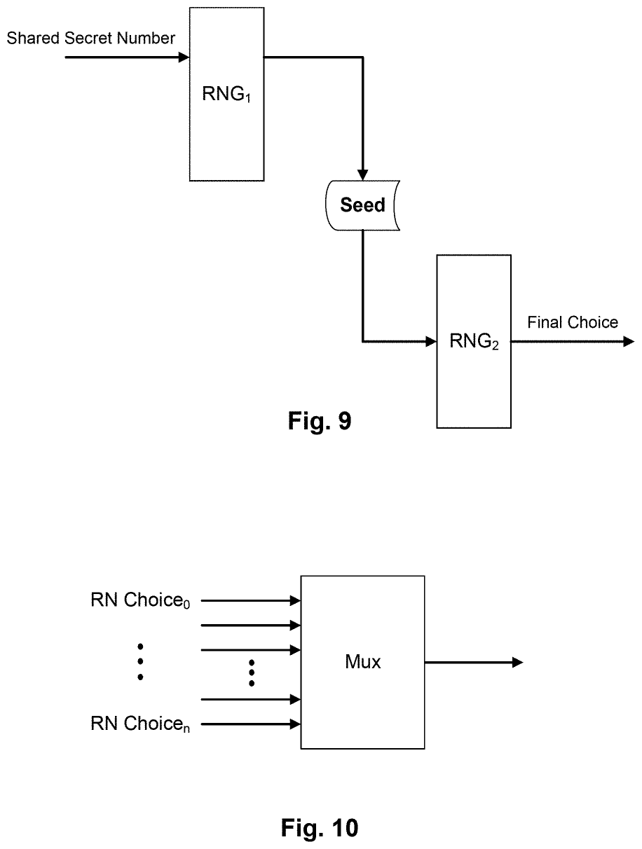

If the key space is set, then calculating the inputs for the functions rely on picking a portion of the signature and then ordering the subset of the signature. The subset of the signature and the order that it is used can be easily passed using a shared secret algorithm, such as a Diffie-Hellman handshake, or similar algorithm. This data is then passed into a series of cryptographic pseudo-random number generators (CPRNGs), or other sources, to further mix the portion of the signature used as inputs as shown in FIG. 9: so that the shared secret is changed more than once. It is also possible that any number of random number generation (RNG) blocks can be chained in order to obscure the final choice. Further, if the RNGs are NOT truly random (a “True Random Number Generator,” or TRNG), then it is quite possible for the users involved in the conversation to predict the output, given that they know how many RNG blocks are used and what RNGs are used in the chain. It is also possible to generalize the RNGs so that they can pick from a pool of RNGs to further obscure the mixing. An RNG block can be constructed using a multiplexer with various cryptographic pseudo-random number generators as inputs. The various CPRNGs do not have to be identically ordered for each block. As long as the order is identical for both users the RNG block structure as shown in FIG. 10 can be used. CPRNGs are chosen since they are the most uniformly random of the RNGs available. The periodicity of the key sequencing will be

$${v}_{sequence} \leq {\prod }_{i = 1}^{n} {v}_{i}$$

where is the periodicity of each constituent RNG block. And vᵢ=μᵢ the average periodicity of the RN choices used as inputs in the RNG block.

Next, the initialization vector (IV) needs to be determined. For a function that is one-to-one the IV can be determined using the relationship

The exact details will depend on the exact final key function used.

Once the final key is developed, the BKE encrypts the final message using the CipherLoc® polymorphic key progression algorithmic cipher engine and the final key.

Next, the partial key is transmitted to the intended recipient followed by the transmission of the encrypted form of the final message.

When the BKE receives an encrypted message and partial key from a valid transmission source, the BKE, essentially, reverses the process used for final key development and encryption.

First, the partial key is used with the appropriate function, chosen from the list below, to develop the final key from the partial key:
1. The identity function—The final key is just the bits read from the PUF in the order specified during the process of data handshake/exchange between the users.
2. The XOR function—The final key is derived by doing an XOR with the IV and the data from the PUF in the specified order.
3. Functions consisting of combinations of binary primitive functions—The final key is derived by applying the agreed upon function consisting of binary primitive operators with the data from the PUF in the specified order. Binary primitives include the AND, OR, and NOT (inversion) binary functions and can be combined in any order as agreed upon prior to application to derive the key.
4. Trigonometric functions—Any trigonometric function, such as sin, cos, tan, sec, cot, and cosec, as well as their hyper-trigonometric counterparts.
5. Locations of portions of an irrational number sequence—Indexing into an irrational number, such as and choosing from some starting point in the sequence to take the next |K| bits as the key. Numerous irrational numbers exist and do not repeat values, any one of which (or selection from among a pool of those numbers) may be selected for use.
6. Other related functions that result in non-repeating values of at least the size of the key—Any equation or number that is known not to repeat for |K| characters is suitable, even though not specified in the preceding descriptions, may also be used to derive the final key.

Any of these functions can be selected, when agreed upon during the initialization sequence seeded by the Initialization Vector and order numbers sent by secret key between users.

Note: If a combination of functions was used to develop the final key, the same combination and sequence of use of those functions is selected.

The full key is derived from an initial value, an initialization vector (IV) and some subset of a signature (S) as K=ƒₜ(IV, S).

The signature is some value, or set of values that uniquely identifies a hardware node associated with a particular user. In order to be a valid signature, the signature must be:
1. Unique—that is each node should have its own value that is different from other nodes. The chance of having a duplicated signature should be as close to random as is possible.
2. All components of the signature must be readable by the unit in which they exist, but not readily available to someone outside the system.
3. Records of the signature should exist ONLY in trusted, protected environments (such as a Trusted Third Party, trusted associated, or Certificate Authority), and ONLY where absolutely necessary.
4. The signature must be composed of values that are difficult, if not impossible, to change for a user. Such a value can be placed in permanently attached hardware or can be the serial number placed in the chips. All processors and communications chips have these numbers burned into them so that they can be tracked and cannot be altered. Further, the hardware and memory configuration can also be added into the full signature.
5. The size of the signature should be as large as is possible. The more bits in the total signature the harder it is to know which portions of the signature are used in any final key.
6. The signature should include as many possible byte values as possible.

Signatures are a concatenation of the various PUFs, serial numbers, and other identifying values that look like:

| | | | | | |
|---|---|---|---|---|---|
| S₀ | S₁ | S₂ | S₃ | . . . | Sₙ |

where each Sᵢ is one of the individual signature components making up the entire signature for the unit. For example S₀ could be the processor serial number, S₁ could be the memory configuration, and so on. But, the signature can have many forms. Specifically, the signature can be concatenated in a number of ways. Without having to permute each of the bits, it is easy to permute each of the components of the total signature. This gives a total of n! combinations of the constituent values. The value of n! rises very rapidly—if there are only five components of the total signature there are 125 possible combinations and with ten, there are 3,628,800 possible combinations. Once this order is created, then any number of combinations of the bits in the signature can be selected. This may be done as a set of bytes or a set of bits. The number of possible combinations of the bits/bytes of the signature is

If the choice is bytes, then n is the number of bytes or bits, as appropriate, in the composite signature and is the size of the partial key input in bytes or bits, as appropriate. Then, the combination of those bits can be chosen in any order, resulting in

$$\begin{matrix}( n ) ! \\ {K}_{p}\end{matrix}$$

choices. This gives a large number of inputs into the function that develops the final key.

Now assume that there are m functions that can be used in developing the final key. These functions are placed in a pool and are randomly chosen, but that choice is agreed upon by the users. Choice of the function can be made in the same way that the signature component order, subset of the signature, and order of the bits/bytes are selected: handshake for each exchange, frequent and irregular seeding, interleaved randomized seeding data in the message, or using a key progression value entered at the time of installation. In any case the best situation is to use a CPRNG that approximates a uniformly distributed IRV. Then we can assume that the probability of selecting any function (t) in the pool is

$${P}_{r} ( {f}_{i} ) = \frac{1}{\vert p \vert} .$$

And the key space for a particular set of messages is the product of the probability of ƒᵢ, n!, and |B|!, resulting in a key space of |K|=n!|B|!|P|.

However, so long as the eventually there will be a repeat of the use of keys in the key space. Assuming that the choice is random, the maximum average amount of keys selected by the users before a repeat (or “collision”) is governed by the Birthday paradox [McKinney 1966]. Having a larger key space will reduce the time between collisions.

Using this approach the idea is to try and achieve as uniform a selection of keys, so that the chance of picking a particular key is given by

$$p r ( K = {K}_{node} ) = \frac{1}{\vert S \vert}$$

and the probability of a collision in a particular run of key selections is

$$p r ( n ) = 1 - {( \frac{\vert K \vert - 1}{\vert K \vert} )}^{\frac{( n ( n - 1 ) )}{2}}$$

Where n is the number of items in the run (such as a run of 23) and |K| is the size of key space. Increasing n only helps to decrease the average time between collisions. Again, the number of possible keys is controlled via the functions and signature space used.

If the key space is set, then calculating the inputs for the functions rely on picking a portion of the signature and then ordering the subset of the signature. The subset of the signature and the order that it is used can be easily passed using a shared secret algorithm, such as a Diffie-Hellman handshake, or similar algorithm. This data is then passed into a series of cryptographic pseudo-random number generators (CPRNGs), or other sources, to further mix the portion of the signature used as inputs as shown in FIG. 9 so that the shared secret is changed more than once. It is also possible that any number of random number generation block (RNGᵢ) can be chained in order to obscure the final choice. Further, if the RNGs are NOT truly random (a “True Random Number Generator,” or TRNG), then it is quite possible for the users involved in the conversation to predict the output, given that they know how many RNG blocks are used and what RNGs are used in the chain. It is also possible to generalize the RNGs so that they can pick from a pool of RNGs to further obscure the mixing. An RNG block can be constructed using a multiplexer with various cryptographic pseudo-random number generators as inputs. The various CPRNGs do not have to be identically ordered for each block. As long as the order is identical for both users the following RNG block structure as shown in FIG. 10 can be used.

CPRNGs are chosen since they are the most uniformly random of the RNGs available. The periodicity of the key sequencing will be v_{sequence}≤Πᵢ₌₁ⁿ vᵢ where v_{sequence} is the periodicity of each constituent RNG block. And vᵢ=μᵢ the average periodicity of the RN choices used as inputs in the RNG block.

Next, the initialization vector (IV) needs to be determined. For a function that is one-to-one the IV can be determined using the relationship IV=ƒ^{il}(S, K) The exact details will depend on the exact final key function used.

Once the final key is developed, the BKE decrypts the final message using the CipherLoc® polymorphic key progression algorithmic cipher engine and the final key.

Finally, the BKE passes the decrypted message to the device to which it is attached, or in which it is embodied, in the original form in which it was intended from the originating device.

### CONCLUSION

The advantages of this approach are that it is possible to develop a key without sending it across a communication channel First of all, it is never sent. Second, this method uses several steps to develop the key that keeps the data well obscured. It can be automated and easily used, as well as easily implemented. Third, there is no need to store the key, so, attacks on the key management system are no longer valid. Fourth, because the PUF key pad is known to both users and is not communicated as part of the exchange, a man in the middle can receive the IV and order and still be unable to reconstruct the key. Only a brute force attack is possible. Fifth, it is extensible to any size key. The process allows for end-to-end protection and uses the CipherLoc® polymorphic key progression algorithmic cipher engine to maximize protection and obscuring.

Note: There are still vulnerabilities to physical attacks. This is not within the goals and scope of the BKE and requires other hybrid measures to accomplish. As with all of the measures taken, the registration process can be vulnerable to a man-in-the-middle attack, but only the first time at registration. Any solution that shares data and needs to communicate will also be susceptible to a DoS or DDoS attack. Again, this type of attack is outside of the scope of the BKE and goals of the design effort.

1. (canceled)

2. (canceled)

3. (canceled)

4. (canceled)

5. (canceled)

6. A method of developing keys in a paired node communications comprising:
performing an initialization sequence;
receiving an message;
determining a partial key having a unique signature, wherein the unique signature is determined using a physically unclonable function;
determining a class function, wherein the class function is chosen from a predetermined list of class functions;
determining an initialization vector;
calculating a final key, wherein the final key is calculated using the class function and at least the initialization vector and unique signature as inputs into the class function;
encrypting the message using the final key and polymorphic key progression;
storing the final key on a memory; and
transmitting the encrypted message to a node.

7. The method of claim 6, wherein the initialization sequence further comprises:
determining a subset of the unique signature;
determining an order of the unique signature;
encrypting the subset and the order using a handshake protocol;
mixing the encrypted subset and encrypted order using at least one cryptographic pseudo-random number generator; and
transmitting the mixed subset and order to the second node.

8. The method of claim 6, wherein the physically unclonable function is derived from a static random access memory, dynamic random access memory, flash memory, resistive random access memory, and/or magneto-resistive random access memory.

9. The method of claim 6, wherein the class function is selected from a group consisting of:
an identity function, XOR function, combinations of binary primitive functions, trigonometric functions, locations of portion of an irrational number sequence, and/or other functions that result in non-repeating values of at least the size of a key space.

10. The method of claim 6, wherein the class function is chosen using a handshake protocol, frequent and irregular seeding, interleaved randomized seeding data in the message, and/or using a key progression value.

11. The method of claim 7, wherein the handshake protocol is a Diffie-Hellman handshake protocol.

12. A computer readable storage medium having program instructions embodied therewith, the program instructions executable by a hardware processor to cause the hardware processor to perform a method comprising:
performing an initialization sequence;
receiving an message;
determining a partial key having a unique signature, wherein the unique signature is determined using a physically unclonable function;
determining a class function, wherein the class function is chosen from a predetermined list of class functions;
determining an initialization vector;
calculating a final key, wherein the final key is calculated using the class function and at least the initialization vector and unique signature as inputs into the class function;
encrypting the message using the final key and polymorphic key progression;
storing the final key on a memory; and
transmitting the encrypted message to a node.

13. The method of claim 12, wherein the initialization sequence further comprises:
determining a subset of the unique signature;
determining an order of the unique signature;
encrypting the subset and the order using a handshake protocol;
mixing the encrypted subset and encrypted order using at least one cryptographic pseudo-random number generator; and
transmitting the mixed subset and order to the second node.

14. The method of claim 12, wherein the physically unclonable function is derived from a static random access memory, dynamic random access memory, flash memory, resistive random access memory, and/or magneto-resistive random access memory.

15. The method of claim 12, wherein the processor is a Field Programmable Gate Array processor.

16. The method of claim 12, wherein the class function is selected from a group consisting of:
an identity function, XOR function, combinations of binary primitive functions, trigonometric functions, locations of portion of an irrational number sequence, and/or other functions that result in non-repeating values of at least the size of a key space.

17. The method of claim 1, wherein the class function is chosen using a handshake protocol, frequent and irregular seeding, interleaved randomized seeding data in the message, and/or using a key progression value.

18. The method of claim 13, wherein the handshake protocol is a Diffie-Hellman handshake protocol.

19. A system for communicating encoded messages, comprising:
a first node having a first memory;
a first processor electrically coupled to the first memory, wherein the first processor is configured to:
perform an initialization sequence;
receive an message;
determine a partial key having a unique signature, wherein the unique signature is determined using a physically unclonable function;
calculate a final key, wherein the final key is calculated using a class function and at least the partial key as inputs into the class function;
encrypt the message using the final key and polymorphic key progression;
store the final key on the first memory; and
transmit the encrypted message to a second node having at least a second memory and a second processor.

20. The system of claim 19, wherein the initialization sequence further comprises:
determine a subset of the unique signature;
determine an order of the unique signature;
encrypt the subset and the order using a handshake protocol;
mix the encrypted subset and encrypted order using at least one cryptographic pseudo-random number generator; and
transmit the mixed subset and order to the second node.

21. The system of claim 19, wherein the physically unclonable function is derived from a static random access memory, dynamic random access memory, flash memory, resistive random access memory, and/or magneto-resistive random access memory.

22. The system of claim 19, wherein both the first processor and the second processor are a Field Programmable Gate Array.

23. The system of claim 19, wherein the class function is selected from a group consisting of:
an identity function, XOR function, combinations of binary primitive functions, trigonometric functions, locations of portion of an irrational number sequence, and/or other functions that result in non-repeating values of at least the size of a key space.

24. The system of claim 19, wherein the class function is chosen using a handshake protocol, frequent and irregular seeding, interleaved randomized seeding data in the message, and/or using a key progression value.

25. The system of claim 20, wherein the handshake protocol is a Diffie-Hellman handshake protocol.
